(19) United States
(12) Patent Application Publication
(10) Pub. No.: US 2025/0150137 A1
(43) Pub. Date: May 8, 2025

(54) SENDING METHOD FOR ASSISTANCE COMMUNICATION DEVICE, COMMUNICATION APPARATUS, AND STORAGE MEDIUM

(71) Applicant: Beijing Xiaomi Mobile Software Co., Ltd., Beijing (CN)

(72) Inventors: Liangang CHI, Beijing (CN); Li YANG, Beijing (CN)

(73) Assignee: Beijing Xiaomi Mobile Software Co., Ltd., Beijing (CN)

(21) Appl. No.: 18/838,069

(22) PCT Filed: Feb. 15, 2022
(86) PCT No.: PCT/CN2022/076383

§ 371 Date: Aug. 13, 2024

(51) Int. Cl. H04B 7/06; H04B 7/04; H04B 7/0456; H04B 17/318

(52) U.S. Cl. CPC H04B 7/0626; H04B 7/04013; H04B 7/0456; H04B 17/328

(57) ABSTRACT

Sending methods for an assistance communication device, communication apparatuses, and storage mediums are provided. The method includes: obtaining indication information for the assistance communication device, where the indication information includes at least one of channel state information (CSI) or a sending scheme; and executing precoding for the assistance communication device based on the indication information, to implement transceiving of signals.

### CROSS-REFERENCE TO RELATED APPLICATIONS

The present disclosure is a U.S. national phase of PCT Application No. PCT/CN2022/076383 filed on Feb. 15, 2022, the content of which is hereby incorporated by reference in its entirety.

### TECHNICAL FIELD

The present disclosure relates to a technical field of communication, and in particular to sending methods for an assistance communication device, communication apparatuses, and storage mediums.

### BACKGROUND

In a communication system, by introducing a precoding technology, an incident signal transmitted from a base station to an RIS (reconfigurable intelligent surface) or a smart repeater is reflected or transparently transmitted to a terminal device (or user equipment) according to a specific direction, to construct an intelligent programmable wireless environment, thereby enhancing a signal strength of a signal received at a side of the terminal device and implementing a channel control.

### SUMMARY

The present disclosure provides sending methods for an assistance communication device, communication apparatuses, and storage mediums.

An embodiment in a first aspect of the present disclosure provides a sending method for an assistance communication device. The method is applied to an assistance communication device and includes:
obtaining indication information for the assistance communication device, where the indication information includes channel state information (CSI) and/or a sending scheme; and executing precoding for the assistance communication device based on the indication information, to implement transceiving of signals.

An embodiment in a second aspect of the present disclosure provides a sending method for an assistance communication device. The method is applied to a network device and includes: sending indication information for the at least one assistance communication device to the at least one assistance communication device, where the indication information includes CSI and/or a sending scheme.

An embodiment in a third aspect of the present disclosure provides a sending method for an assistance communication device. The method is applied to a terminal device and includes: sending indication information for the assistance communication device to a network device, where the indication information includes CSI.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the first aspect.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the second aspect.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the third aspect.

An embodiment in yet another aspect of the present disclosure provides a non-transitory computer-readable storage medium, configured to store instructions. When the instructions are executed, the method provided in the embodiment of the first aspect is implemented.

An embodiment in yet another aspect of the present disclosure provides a non-transitory computer-readable storage medium, configured to store instructions. When the instructions are executed, the method provided in the embodiment of the second aspect is implemented.

An embodiment in yet another aspect of the present disclosure provides a non-transitory computer-readable storage medium, configured to store instructions. When the instructions are executed, the method provided in the embodiment of the third aspect is implemented.

Additional aspects and advantages of the present disclosure will be set forth in part in the following description, and a part thereof will become apparent from the following description or be learned by practice of the present disclosure.

### BRIEF DESCRIPTION OF DRAWINGS

The above and/or additional aspects and advantages of the present disclosure will become apparent and readily understood from the following description of embodiments in conjunction with the accompanying drawings.

FIG. 1 is a schematic flowchart of a sending method for an assistance communication device provided by an embodiment of the present disclosure.

FIG. 2 is a schematic flowchart of a sending method for an assistance communication device provided by another embodiment of the present disclosure.

FIG. 3 is a schematic flowchart of a sending method for an assistance communication device provided by another embodiment of the present disclosure.

FIG. 4 is a schematic flowchart of a sending method for an assistance communication device provided by yet another embodiment of the present disclosure.

FIG. 5 is a schematic flowchart of a sending method for an assistance communication device provided by yet another embodiment of the present disclosure.

FIG. 6 is a schematic flowchart of a sending method for an assistance communication device provided by yet another embodiment of the present disclosure.

FIG. 7 is a schematic flowchart of a sending method for an assistance communication device provided by yet another embodiment of the present disclosure.

FIG. 8 is a schematic flowchart of a sending method for an assistance communication device provided by yet another embodiment of the present disclosure.

FIG. 9 is a schematic flowchart of a sending method for an assistance communication device provided by yet another embodiment of the present disclosure.

FIG. 10 is a schematic flowchart of a sending method for an assistance communication device provided by yet another embodiment of the present disclosure.

FIG. 11a is a schematic flowchart of a sending method for an assistance communication device provided by yet another embodiment of the present disclosure.

FIG. 11b is a schematic flowchart of a sending method for an assistance communication device provided by yet another embodiment of the present disclosure.

FIG. 12a is a schematic flowchart of a sending method for an assistance communication device provided by yet another embodiment of the present disclosure.

FIG. 12b is a schematic flowchart of a sending method for an assistance communication device provided by yet another embodiment of the present disclosure.

FIG. 13 is a schematic flowchart of a sending method for an assistance communication device provided by yet another embodiment of the present disclosure.

FIG. 14 is a schematic structural diagram of a sending apparatus for an assistance communication device provided by an embodiment of the present disclosure.

FIG. 15 is a schematic structural diagram of a sending apparatus for an assistance communication device provided by another embodiment of the present disclosure.

FIG. 16 is a schematic structural diagram of a sending apparatus for an assistance communication device provided by yet another embodiment of the present disclosure.

FIG. 17 is a block diagram of a terminal device provided by an embodiment of the present disclosure.

FIG. 18 is a block diagram of a base station provided by an embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. On the contrary, they are only examples of apparatuses and methods that are consistent with some aspects of embodiments of the present disclosure as detailed in the attached claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, terms “if” and “in case of” used herein can be interpreted as “when,” “while,” or “in response to determining.”

Embodiments of the present disclosure are described in detail below. Examples of the embodiments are shown in the accompanying drawings, where same or similar reference signs throughout represent same or similar elements. The embodiments described herein with reference to the accompanying drawings are exemplary and intended to explain the present disclosure, but cannot be understood as limiting the present disclosure.

In a related technology, the precoding of the smart repeater/RIS and the precoding of the base station are jointly designed mainly by an alternate optimization technology. However, a sending method for an assistance communication device implemented based on the alternate optimization technology needs to separately use different algorithms to jointly design the precoding of the smart repeater/RIS and the precoding of the base station, which results in a relatively high complexity and a relatively poor applicability.

The present disclosure provides sending methods and devices for an assistance communication device, communication apparatuses, and storage mediums, to solve the technical problems of the relatively high complexity and poor applicability for the sending method for an assistance communication device in the related technology.

The sending methods and devices for an assistance communication device, storage mediums, and apparatuses provided by the present disclosure will be described in detail below with reference to the accompanying drawings.

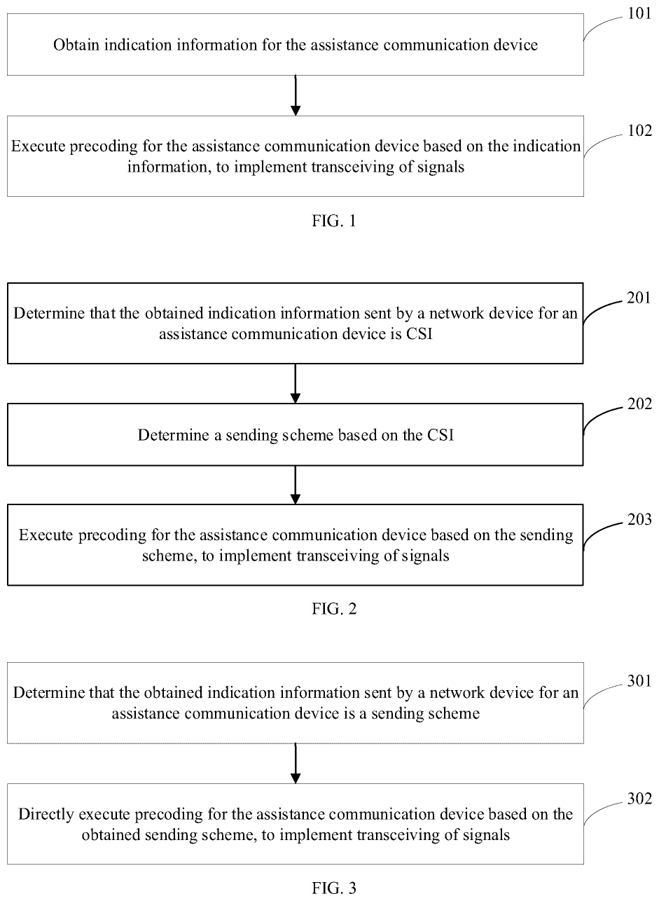

FIG. 1 is a schematic flowchart of a sending method for an assistance communication device provided by an embodiment of the present disclosure. The method is executed by an assistance communication device. As shown in FIG. 1, the sending method for an assistance communication device may include the following steps 101-102.
At step 101, indication information for the assistance communication device is obtained.

In an embodiment of the present disclosure, the assistance communication device may be an RIS array and/or a smart repeater.

In addition, in an embodiment of the present disclosure, the indication information may include CSI (channel state information) and/or a sending scheme.

Specifically, in an embodiment of the present disclosure, the CSI includes at least one of: a precoding matrix; a PMI (precoding matrix index); an offset phase value; an RSRP (reference signal receiving power); or a direct or indirect identifier of a measurement reference signal, for indicating the measurement reference signal corresponding to the CSI.

In an embodiment of the present disclosure, the offset phase value for the assistance communication device is a difference value between a phase of transceiving signals on a channel (that is, a communication link between the assistance communication device and a terminal device) for the assistance communication device and a phase of transceiving signals on a channel (that is, a communication link between a reference assistance communication device and the terminal device) for the reference assistance communication device. In addition, in an embodiment of the present disclosure, the reference assistance communication device may be any one selected assistance communication device.

In addition, in an embodiment of the present disclosure, the direct or indirect identifier of the measurement reference signal may be used to uniquely indicate the measurement reference signal. The measurement reference signal may be a reference signal transmitted on the communication link between the assistance communication device and the terminal device, and the CSI is obtained by measuring the reference signal. Based on this, the measurement reference signal corresponding to the CSI may be determined by enabling the CSI to include the direct or indirect identifier of the measurement reference signal, and then the assistance communication device for the CSI may be determined.

For example, in an embodiment of the present disclosure, the direct or indirect identifier of the measurement reference signal may be an index of the measurement reference signal. In another embodiment of the present disclosure, the direct or indirect identifier of the measurement reference signal may be an identifier of a resource used by the measurement reference signal.

In addition, in an embodiment of the present disclosure, the sending scheme may include precoding information and/or sending power information. The precoding information may include a PMI and/or incident angle information, and the sending power information may be a sending power coefficient for the communication link between the assistance communication device and the terminal device. It should be noted that in an embodiment of the present disclosure, when there are different types of assistance communication devices, the sending scheme also includes different contents, and the contents will be described in detail in subsequent embodiments.

In addition, it should be noted that in an embodiment of the present disclosure, both the CSI and the sending scheme are determined based on a channel condition of the communication link between the assistance communication device and the terminal device. In addition, based on different channel conditions of communication links between different assistance communication devices and the terminal device, the different assistance communication devices will correspond to different CSIs and sending schemes. In an embodiment of the present disclosure, each of the assistance communication devices obtains the CSI and/or sending scheme for the assistance communication device.
At step 102, precoding is executed for the assistance communication device based on the indication information, to implement transceiving of signals.

In an embodiment of the present disclosure, the indication information may include CSI and/or a sending scheme; the assistance communication device may include an RIS or a smart repeater, and when there are different indication information or assistance communication devices. There are also different methods for executing precoding for the assistance communication device based on the indication information. This content will be described in detail in subsequent embodiments.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

FIG. 2 is a schematic flowchart of another sending method for an assistance communication device provided by an embodiment of the present disclosure. The method is executed by an assistance communication device. As shown in FIG. 2, the sending method for an assistance communication device may include the following steps 201-203.
At step 201, it is determined that the obtained indication information, sent by a network device for an assistance communication device, is CSI.

In an embodiment of the present disclosure, the detailed description of step 201 may refer to related description in the described embodiments, which will be not repeated in the embodiment of the present disclosure here.
At step 202, a sending scheme is determined based on the CSI.

In an embodiment of the present disclosure, both the precoding information and the sending power information in the sending scheme may be determined by the assistance communication device based on the CSI. In another embodiment of the present disclosure, the precoding information in the sending scheme may be determined by the assistance communication device based on the CSI, and the sending power information in the sending scheme may be sent by the network device to the assistance communication device.
At step 203, the precoding is executed for the assistance communication device based on the sending scheme, to implement transceiving of signals.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

FIG. 3 is a schematic flowchart of another sending method for an assistance communication device provided by an embodiment of the present disclosure. The method is executed by an assistance communication device. As shown in FIG. 3, the sending method for an assistance communication device may include the following steps 301-302.
At step 301, it is determined that the obtained indication information, sent by a network device for an assistance communication device, is a sending scheme.

In an embodiment of the present disclosure, the detailed description of step 301 may refer to related description in the embodiments, which will be not repeated in the embodiment of the present disclosure here.
At step 302, the precoding is directly executed for the assistance communication device based on the obtained sending scheme, to implement transceiving of signals.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

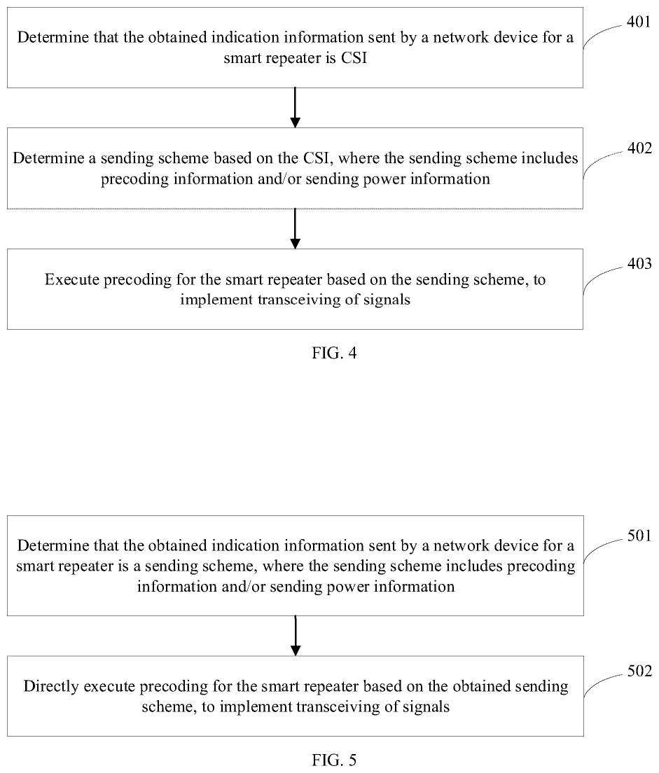

FIG. 4 is a schematic flowchart of another sending method for an assistance communication device provided by an embodiment of the present disclosure. The method is executed by an assistance communication device. The assistance communication device is a smart repeater. As shown in FIG. 4, the sending method for an assistance communication device may include the following steps 401-403.
At step 401, it is determined that the obtained indication information, sent by a network device for a smart repeater, is CSI.

In an embodiment of the present disclosure, the detailed description of step 401 may refer to related description in the embodiments, which will be not repeated in the embodiment of the present disclosure here.
At step 402, a sending scheme is determined based on the CSI, where the sending scheme includes precoding information and sending power information.

In an embodiment of the present disclosure, the precoding information may include only a PMI.

In addition, in an embodiment of the present disclosure, after the smart repeater receives the CSI for the smart repeater, the smart repeater may determine the precoding information for the smart repeater according to the received CSI. In addition, in an embodiment of the present disclosure, the sending power information may be determined by the smart repeater autonomously (or based on the CSI). In another embodiment of the present disclosure, the sending power information may be sent by the network device to the smart repeater.
At step 403, the precoding is executed for the smart repeater based on the sending scheme, to implement transceiving of signals.

In an embodiment of the present disclosure, the smart repeater may determine a precoding matrix and/or an offset phase matrix for the smart repeater according to the precoding information in the sending scheme, then form a composite beam according to the precoding matrix and/or the offset phase matrix, and determine a sending power (the sending power may be a downlink sending power for the communication link between the assistance communication device and the terminal device) based on the sending power information in the sending scheme, such that the smart repeater may send the composite beam based on the sending power.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

FIG. 5 is a schematic flowchart of still another sending method for an assistance communication device provided by an embodiment of the present disclosure. The method is executed by an assistance communication device. The assistance communication device is a smart repeater. As shown in FIG. 5, the sending method for an assistance communication device may include the following steps 501-502.
At step 501, it is determined that the obtained indication information, sent by a network device for a smart repeater, is a sending scheme, where the sending scheme includes precoding information and/or sending power information.

In an embodiment of the present disclosure, the precoding information in the sending scheme may include a PMI.

In addition, it should be noted that in an embodiment of the present disclosure, if the sending scheme, sent by the network device, for the smart repeater does not include the sending power information, the smart repeater may autonomously determine the sending power information.
At step 502, the precoding is directly executed for the smart repeater based on the obtained sending scheme, to implement transceiving of signals.

In an embodiment of the present disclosure, after the smart repeater receives the sending scheme, the smart repeater may directly determine, by the precoding information in the sending scheme, a precoding matrix and/or an offset phase matrix to form a beam, then form a composite beam according to the precoding matrix and/or the offset phase matrix, and determine a sending power (the sending power may be a downlink sending power for the communication link between the assistance communication device and the terminal device) based on the sending power information in the sending scheme, such that the smart repeater may send the composite beam based on the sending power.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

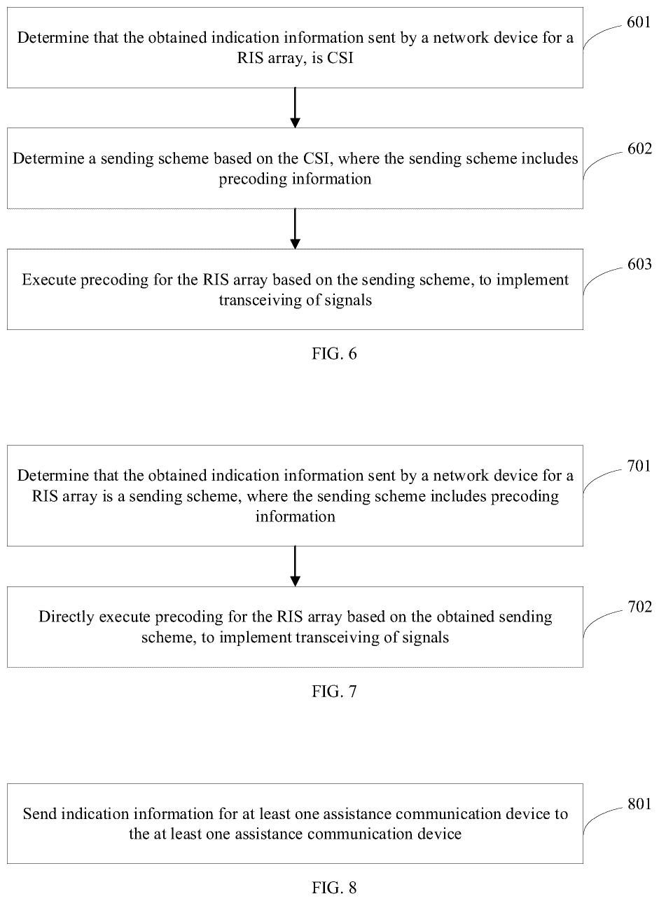

FIG. 6 is a schematic flowchart of yet another sending method for an assistance communication device provided by an embodiment of the present disclosure. The method is executed by an assistance communication device. The assistance communication device is an RIS array. As shown in FIG. 6, the sending method for an assistance communication device may include the following steps 601-603.
At step 601, it is determined that the obtained indication information, sent by a network device for a RIS array, is CSI.

In an embodiment of the present disclosure, the detailed description of step 601 may refer to related description in the embodiments, which will be not repeated in the embodiment of the present disclosure here.
At step 602, a sending scheme is determined based on the CSI, where the sending scheme includes precoding information.

In an embodiment of the present disclosure, the precoding information in the sending scheme may include a PMI and/or incident angle information.

Specifically, in an embodiment of the present disclosure, after the assistance communication device receives the CSI sent by the network device, the assistance communication device may directly determine the PMI and/or the incident angle information based on the CSI.

In another embodiment of the present disclosure, after the assistance communication device receives the CSI sent by the network device, the assistance communication device may directly determine the PMI based on the CSI, and the incident angle information may be separately sent by the network device to the assistance communication device.
At step 603, the precoding is executed for the RIS array based on the sending scheme, to implement transceiving of signals.

In addition, in an embodiment of the present disclosure, the RIS array may obtain an offset phase angle in each of RIS units of the RIS array based on the PMI and the incident angle information in the sending scheme, determine an offset phase matrix for the RIS array based on the offset phase angle in each of the RIS units, and then executes transceiving of signals by the offset phase matrix.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

FIG. 7 is a schematic flowchart of yet another sending method for an assistance communication device provided by an embodiment of the present disclosure. The method is executed by an assistance communication device. The assistance communication device is an RIS array. As shown in FIG. 7, the sending method for an assistance communication device may include the following steps 701-702.
At step 701, it is determined that the obtained indication information, sent by a network device for a RIS array, is a sending scheme, where the sending scheme includes precoding information.

In an embodiment of the present disclosure, the precoding information in the sending scheme may include a PMI and/or incident angle information.
At step 702, the precoding is directly executed for the RIS array based on the obtained sending scheme, to implement transceiving of signals.

In addition, in an embodiment of the present disclosure, after the RIS array receives the sending scheme, the RIS array may obtain an offset phase angle in each of RIS units of the RIS array based on the PMI and the incident angle information in the sending scheme, determine an offset phase matrix for the RIS array based on the offset phase angle in each of the RIS units, and then executes transceiving of signals by the offset phase matrix.

In conclusion, in the sending method for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

FIG. 8 is a schematic flowchart of yet another sending method for an assistance communication device provided by an embodiment of the present disclosure. The method is executed by a network device. As shown in FIG. 8, the sending method for an assistance communication device may include the following step 801.
At step 801, indication information for the at least one assistance communication device is sent to the at least one assistance communication device.

In an embodiment of the present disclosure, the assistance communication device may be an RIS and/or a smart repeater.

In addition, in an embodiment of the present disclosure, the indication information may include CSI and/or a sending scheme. The detailed description of the CSI and the sending scheme may refer to the related description of the embodiments, which will not be repeated in the embodiment of the present disclosure here.

Further, in an embodiment of the present disclosure, the network device may send the indication information for the at least one assistance communication device to the at least one assistance communication device through signaling.

It should be noted that in an embodiment of the present disclosure, the network device specifically sends, to each of the at least one assistance communication device, the indication information for the assistance communication device.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

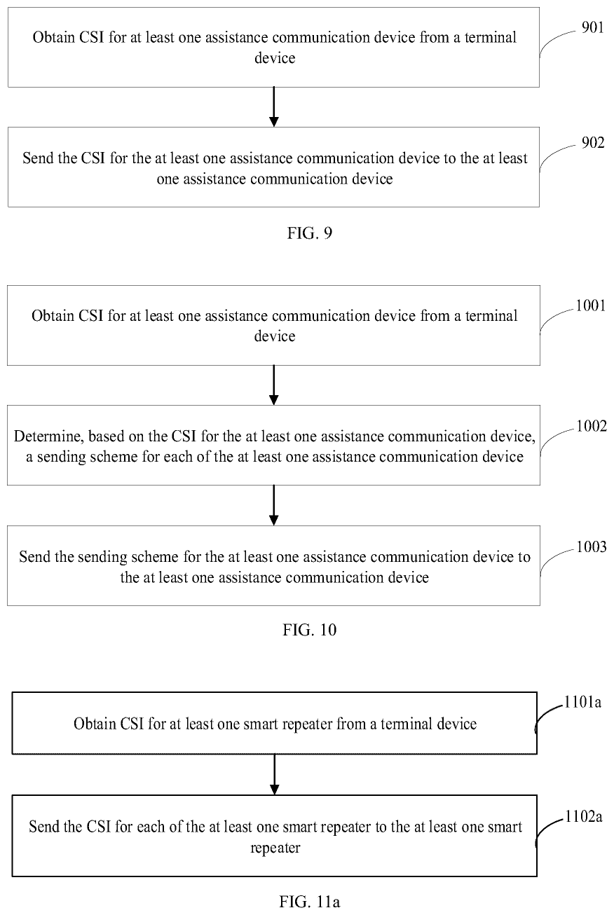

FIG. 9 is a schematic flowchart of yet another sending method for an assistance communication device provided by an embodiment of the present disclosure. The method is executed by a network device. As shown in FIG. 9, the embodiment of FIG. 9 is an embodiment in which the indication information is the CSI, and the sending method for an assistance communication device may include the following steps 901-902.
At step 901, the CSI for the at least one assistance communication device is obtained from a terminal device.

In an embodiment of the present disclosure, the terminal device may be a device providing voice and/or data connectivity to a user. The terminal device may communicate with one or more core networks through an RAN (radio access network). The terminal device may be an Internet of Things terminal, such as a sensor device, a mobile phone (or referred to as a “cellular” phone), and a computer having the Internet of Things terminal, for example a fixed, portable, pocket, handheld, computer built-in, or vehicle-mounted apparatus. For example, the terminal device may be a station (STA), a subscriber unit, a subscriber station, a mobile station, a mobile table, a remote station, an access point, a remote terminal, an access terminal, a user terminal, or a user agent. Alternatively, the terminal device may also be a device of an unmanned aerial vehicle. Alternatively, the terminal device may also be a vehicle-mounted device, for example, a vehicle computer having a wireless communication function, or a wireless terminal externally connected to a vehicle computer. Alternatively, the terminal device may also be a roadside device, for example, a street lamp, a signal light, other roadside device, etc., having a wireless communication function.

It should be noted that in an embodiment of the present disclosure, the CSI sent by the terminal device to the network device may include at least one of: a precoding matrix; a PMI; an offset phase value; an RSRP; or a direct or indirect identifier of a measurement reference signal, for indicating the measurement reference signal corresponding to the CSI.

In addition, it should be noted that in an embodiment of the present disclosure, the PMI in the CSI sent by the terminal device to the network device is a precoding matrix index applicable to a precoding sequence in a conventional method, while the PMI in the CSI sent by the network device to the assistance communication device is a precoding matrix index applicable to the assistance communication device.
At step 902, CSI for at least one assistance communication device is sent to the at least one assistance communication device.

In an embodiment of the present disclosure, the network device may send the obtained CSI for the at least one assistance communication device to the at least one assistance communication device through signaling, so that the assistance communication device may determine the sending scheme based on the CSI, and then execute the precoding based on the sending scheme.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

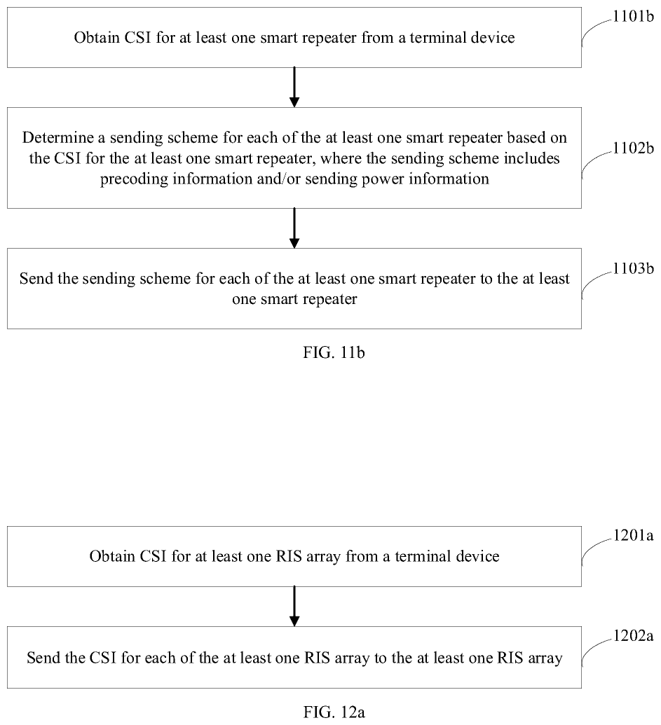

FIG. 10 is a schematic flowchart of yet another sending method for an assistance communication device provided by an embodiment of the present disclosure. The method is executed by a network device. As shown in FIG. 10, the embodiment of FIG. 10 is an embodiment in which the indication information is the sending scheme, and the sending method for an assistance communication device may include the following steps 1001-1003.
At step 1001, the CSI for the at least one assistance communication device is obtained from a terminal device.
At step 1002, based on the CSI for the at least one assistance communication device, the sending scheme for the assistance communication device is determined.

The related detailed description of the sending scheme may refer to the description of the embodiments, which will not be repeated in the embodiment of the present disclosure here.
At step 1003, the sending scheme for the at least one assistance communication device is sent to the at least one assistance communication device.

In an embodiment of the present disclosure, the network device may send the sending scheme for the at least one assistance communication device to the at least one assistance communication device through signaling.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

FIG. 11a is a schematic flowchart of yet another sending method for an assistance communication device provided by an embodiment of the present disclosure. The method is executed by a network device. The assistance communication device is a smart repeater. As shown in FIG. 11a, the embodiment of FIG. 11a is an embodiment in which the indication information is the CSI, and the sending method for an assistance communication device may include the following steps 1101a-1102a.
At step 1101a, the CSI for the at least one smart repeater is obtained from a terminal device.
At step 1102a, CSI for each of the at least one smart repeater is sent to the at least one smart repeater.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

FIG. 11b is a schematic flowchart of yet another sending method for an assistance communication device provided by an embodiment of the present disclosure. The method is executed by a network device. The assistance communication device is a smart repeater. As shown in FIG. 11b, the embodiment of FIG. 11b is an embodiment in which the indication information is the sending scheme, and the sending method for an assistance communication device may include the following steps 1101b-1103b.
At step 1101b, the CSI for the at least one smart repeater is obtained from a terminal device.
At step 1102b, a sending scheme for each of the at least one smart repeater is determined based on the CSI for the at least one smart repeater, where the sending scheme includes precoding information and/or sending power information.

In an embodiment of the present disclosure, the precoding information in the sending scheme may include a PMI.

In addition, in an embodiment of the present disclosure, the sending power information may be a sending power coefficient for a communication link between the assistance communication device and the terminal device.
At step 1103b, the sending scheme for each of the at least one smart repeater is sent to the at least one smart repeater.

In an embodiment of the present disclosure, the smart repeater receives the sending scheme for the smart repeater, and then may directly execute the precoding for the smart repeater based on the obtained sending scheme.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

FIG. 12a is a schematic flowchart of yet another sending method for an assistance communication device provided by an embodiment of the present disclosure. The method is executed by a network device. The assistance communication device is a smart repeater. As shown in FIG. 12a, the embodiment of FIG. 12a is an embodiment in which the indication information is the CSI, and the sending method for an assistance communication device may include the following steps 1201a-1202a.
At step 1201a, CSI for the at least one RIS array is obtained from a terminal device.
At step 1202a, the CSI for each of the at least one RIS array is sent to the at least one RIS array.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

FIG. 12b is a schematic flowchart of yet another sending method for an assistance communication device provided by an embodiment of the present disclosure. The method is executed by a network device. The assistance communication device is an RIS array. As shown in FIG. 12b, the embodiment of FIG. 12b is an embodiment in which the indication information is the sending scheme, and the sending method for an assistance communication device may include the following steps 1201b-1203b.
At step 1201b, CSI for the at least one RIS array is obtained from a terminal device.
At step 1202b, a sending scheme for each of the at least one RIS array is determined based on the CSI for the at least one RIS array, where the sending scheme includes precoding information and/or sending power information.

In an embodiment of the present disclosure, the precoding information in the sending scheme may include a PMI and/or incident angle information.
At step 1203b, the sending scheme for each of the at least one RIS array is sent to the at least one RIS array.

In an embodiment of the present disclosure, after the network device sends the sending scheme for the at least one RIS array to the at least one RIS array, the RIS array may directly execute the precoding for the RIS array based on the obtained sending scheme.

In conclusion, in the sending method for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

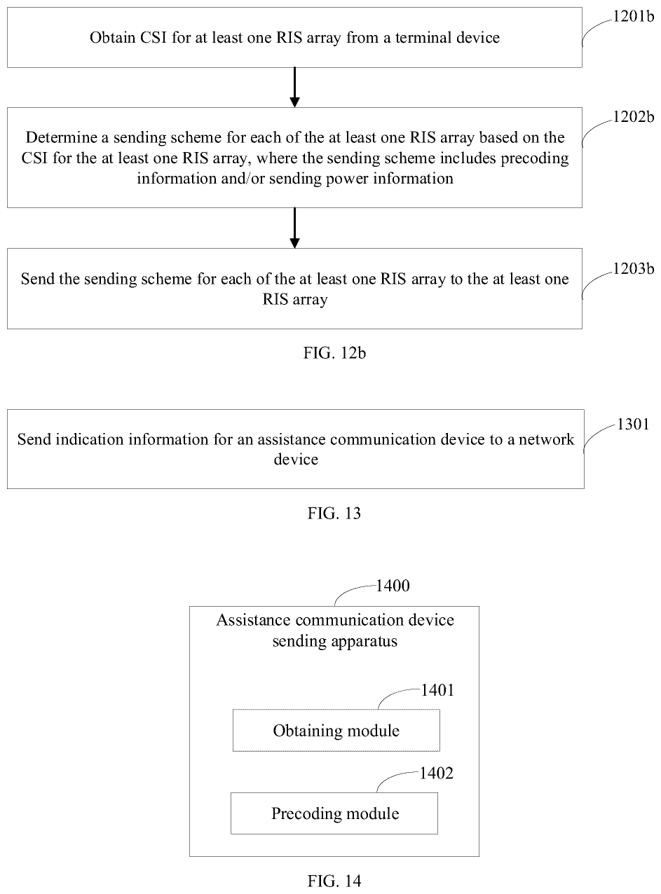

FIG. 13 is a schematic flowchart of yet another sending method for an assistance communication device provided by an embodiment of the present disclosure. The method is executed by a terminal device. As shown in FIG. 13, the sending method for an assistance communication device may include the following step 1301.
At step 1301, indication information for the assistance communication device is sent to a network device.

In an embodiment of the present disclosure, the assistance communication device may be an RIS and/or a smart repeater.

In addition, in an embodiment of the present disclosure, the indication information may include CSI. The detailed description of the CSI may refer to the related description of the embodiments, which will not be repeated in the embodiment of the present disclosure here.

In addition, in an embodiment of the present disclosure, the terminal device sends the indication information for the at least one assistance communication device to the network device by at least one of: directly sending the indication information for the assistance communication device to the network device; or sending, through the assistance communication device, the indication information for the assistance communication device to the network device.

In addition, it should be noted that in an embodiment of the present disclosure, the terminal device may specifically feed back the PMI in the CSI, based on an assumption that a phase of each of array elements of the RIS array is continuously adjustable.

In conclusion, in the sending method for an assistance communication device provided by the embodiment of the present disclosure, the terminal device may send the indication information for the assistance communication device to the network device. It can be seen that in the embodiment of the present disclosure, the assistance communication device may execute the precoding by the obtained CSI and/or sending scheme, which causes a relatively low complexity and a relatively high applicability.

FIG. 14 is a schematic structural diagram of a sending apparatus 1400 for an assistance communication device provided by an embodiment of the present disclosure. The apparatus is applied to an assistance communication device. As shown in FIG. 14, the sending apparatus for an assistance communication device 1400 may include an obtaining module 1401 and a precoding module 1402.

The obtaining module 1401 is configured to obtain indication information for the assistance communication device, where the indication information includes channel state information (CSI) and/or a sending scheme.

The precoding module 1402 is configured to execute precoding for the assistance communication device based on the indication information, to implement transceiving of signals.

In conclusion, in the sending apparatus 1400 for an assistance communication device provided by the embodiment of the present disclosure, the assistance communication device may obtain indication information for the assistance communication device, where the indication information includes the CSI and/or sending scheme, and then the assistance communication device may execute the precoding for the assistance communication device based on the indication information, to implement transceiving of signals. It can be seen that in the embodiment of the present disclosure, the assistance communication device may execute the precoding by the obtained CSI and/or sending scheme, which causes a relatively low complexity and a relatively high applicability.

In an embodiment of the present disclosure, the obtaining module 1401 is further configured to: obtain the indication information sent by a network device.

Further, in another embodiment of the present disclosure, the CSI includes at least one of: a precoding matrix; a PMI; an offset phase value; an RSRP; or a direct or indirect identifier of a measurement reference signal, for indicating the measurement reference signal corresponding to the CSI.

Further, in another embodiment of the present disclosure, the offset phase value for the assistance communication device is a difference value between a phase of transceiving signals on a channel for the assistance communication device and a phase of transceiving signals on a channel for a reference assistance communication device; where the reference assistance communication device is any one selected assistance communication device.

Further, in another embodiment of the present disclosure, the CSI for the assistance communication device is obtained by at least one of: obtaining the CSI sent by the network device; or obtaining the CSI sent by the terminal device.

Further, in another embodiment of the present disclosure, the precoding module 1402 is further configured to: in response to determining that the indication information is the CSI, determine a sending scheme based on the CSI; and execute the precoding for the assistance communication device based on the sending scheme.

Further, in another embodiment of the present disclosure, the obtaining module 1401 is further configured to: obtain the indication information sent by a network device; in response to determining that the indication information is the sending scheme for the assistance communication device, the precoding module 1402 is further configured to execute directly the precoding for the assistance communication device based on the obtained sending scheme.

Further, in another embodiment of the present disclosure, the assistance communication device is a smart repeater.

Further, in another embodiment of the present disclosure, the sending scheme includes precoding information and/or sending power information, and the precoding information includes a PMI.

Further, in another embodiment of the present disclosure, the assistance communication device is an RIS.

Further, in another embodiment of the present disclosure, the sending scheme includes precoding information, and the precoding information includes a PMI and/or incident angle information.

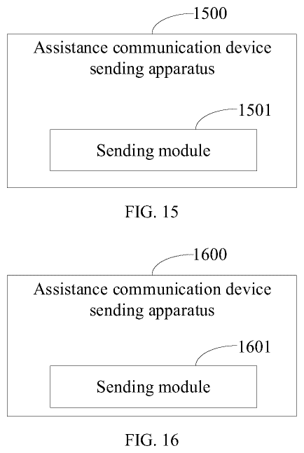

FIG. 15 is a schematic structural diagram of yet another sending apparatus 1500 for an assistance communication device provided by an embodiment of the present disclosure. The apparatus is applied to network device. As shown in FIG. 15, the sending apparatus for an assistance communication device 1500 may include a sending module 1501.

The sending module 1501 is configured to send indication information for the at least one assistance communication device to the at least one assistance communication device, where the indication information includes channel state information (CSI) and/or a sending scheme.

In conclusion, in the sending apparatus for an assistance communication device provided by the embodiment of the present disclosure, the network device may send the indication information for the at least one assistance communication device to the at least one assistance communication device. It can be seen that in the embodiment of the present disclosure, the assistance communication device may execute the precoding by the obtained CSI and/or sending scheme, which causes a relatively low complexity and a relatively high applicability.

In an embodiment of the present disclosure, the CSI includes at least one of: a precoding matrix; a PMI; an offset phase value; an RSRP; or a direct or indirect identifier of a measurement reference signal, for indicating the measurement reference signal corresponding to the CSI.

Further, in another embodiment of the present disclosure, the offset phase value for the assistance communication device is a difference value between a phase of transceiving signals on a channel for the assistance communication device and a phase of transceiving signals on a channel for a reference assistance communication device; where the reference assistance communication device is any one selected assistance communication device.

Further, in another embodiment of the present disclosure, in response to determining that the indication information is CSI, the apparatus 1500 is further configured to: obtain the CSI for the at least one assistance communication device from a terminal device.

Further, in another embodiment of the present disclosure, in response to determining that the indication information is the sending scheme, the sending module 1501 is further configured to: obtain the CSI for the at least one assistance communication device from a terminal device; and determine, based on the CSI for the at least one assistance communication device, the sending scheme for the assistance communication device.

Further, in another embodiment of the present disclosure, the assistance communication device is a smart repeater.

Further, in another embodiment of the present disclosure, the sending scheme includes precoding information and/or sending power information, and the precoding information includes a PMI.

Further, in another embodiment of the present disclosure, the assistance communication device is an RIS.

Further, in another embodiment of the present disclosure, the sending scheme includes precoding information, and the precoding information includes a PMI and/or incident angle information.

FIG. 16 is a schematic structural diagram of yet another sending apparatus 1600 for an assistance communication device provided by an embodiment of the present disclosure. The apparatus is applied to a terminal device. As shown in FIG. 16, the sending apparatus for an assistance communication device 1600 may include a sending module 1601.

The sending module 1601 is configured to send indication information for the assistance communication device to a network device, where the indication information includes CSI.

In conclusion, in the sending apparatus 1600 for an assistance communication device provided by the embodiment of the present disclosure, the terminal device may send the indication information for the assistance communication device to the network device. It can be seen that in the embodiment of the present disclosure, the assistance communication device may execute the precoding by the obtained CSI and/or sending scheme, which causes a relatively low complexity and a relatively high applicability.

In an embodiment of the present disclosure, the sending module 1601 is further configured to: send the CSI for the assistance communication device to the network device and/or the assistance communication device.

Further, in another embodiment of the present disclosure, the CSI includes at least one of: a precoding matrix; a PMI; an offset phase value; an RSRP; or a direct or indirect identifier of a measurement reference signal, for indicating the measurement reference signal corresponding to the CSI.

Further, in another embodiment of the present disclosure, the offset phase value for the assistance communication device is a difference value between a phase of transceiving signals on a channel for the assistance communication device and a phase of transceiving signals on a channel for a reference assistance communication device; where the reference assistance communication device is any one selected assistance communication device.

Further, in another embodiment of the present disclosure, sending the indication information for the at least one assistance communication device to the network device includes at least one of: directly sending the indication information for the assistance communication device to the network device; or sending, through the assistance communication device, the indication information for the assistance communication device to the network device.

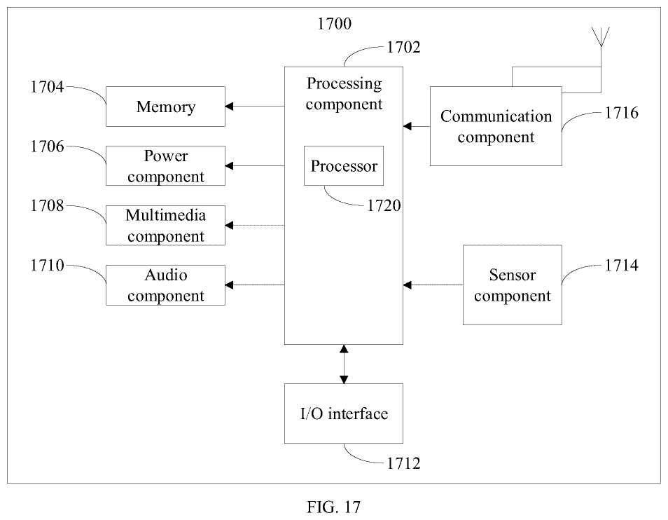

FIG. 17 is a block diagram of a terminal device 1700 provided by an embodiment of the present disclosure. For example, the terminal device 1700 may be a mobile phone, a computer, digital broadcast terminal device, a message transceiving device, a game console, a tablet device, a medical device, a fitness device, a personal digital assistant, etc.

Referring to FIG. 17, the terminal device 1700 may include at least one of the following components: a processing component 1702, a memory 1704, a power component 1706, a multimedia component 1708, an audio component 1710, an input/output (I/O) interface 1712, a sensor component 1714, and a communication component 1716.

The processing component 1702 controls the overall operation of the terminal device 1700, such as operations associated with display, phone calls, data communication, camera operations, and recording operations. The processing component 1702 may include at least one processor 1720 to execute instructions to complete all or part of the steps in the methods. Additionally, the processing component 1702 may include at least one module to facilitate interaction between the processing component 1702 and other components. For example, the processing component 1702 may include a multimedia module to facilitate interaction between the multimedia component 1708 and the processing component 1702.

The memory 1704 is configured to store various types of data to support operations of the terminal device 1700. Examples of such data include instructions, contact data, phonebook data, messages, pictures, videos, etc., for any application program or method operating on the terminal device 1700. The memory 1704 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1706 provides power to various components of the terminal device 1700. The power component 1706 may include a power supply management system, at least one power supply, and other components that are associated with generating, managing, and distributing power for the terminal device 1700.

The multimedia component 1708 includes a screen providing an output interface between the terminal device 1700 and the user. In some embodiments, the screen may include a liquid crystal display (LCD) and a touch panel (TP). If the screen includes the touch panel, the screen may be implemented as a touch screen, to receive an input signal from the user. The touch panel includes at least one touch sensor to sense the touch, the slide, and the gesture on the touch panel. The touch sensor may not only sense a boundary of the touch or slide action, but also detect a wake-up time and pressure related to the touch or slide operation. In some embodiments, the multimedia component 1708 includes a front facing camera and/or a rear facing camera. When the terminal device 1700 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 1710 is configured to output and/or input audio signals. For example, the audio component 1710 includes a microphone (MIC). The microphone is configured to receive external audio signals when the terminal device 1700 is in the operating mode, such as a call mode, a recording mode, and a speech recognition mode. The received audio signals may be further stored in the memory 1704 or sent via the communication component 1716. In some embodiments, the audio component 1710 also includes a speaker for outputting the audio signals.

The I/O interface 1712 provides an interface between the processing component 1702 and peripheral interface modules. The peripheral interface modules may be keyboards, click wheels, buttons, etc. These buttons may include but are not limited to: a home button, a volume button, a start button, and a lock button.

The sensor component 1714 includes at least one sensor to provide various aspects of state assessment for the terminal device 1700. For example, the sensor component 1714 may detect an open/closed state of the terminal device 1700, relative positioning of components that are for example a display and keypad of the terminal device 1700. The sensor component 1714 may also detect a position change of the terminal device 1700 or of a component of the terminal device 1700, presence or absence of the user contacting with the terminal device 1700, an orientation or acceleration/deceleration of the terminal device 1700, and a temperature change of the terminal device 1700. The sensor component 1714 may include a proximity sensor configured to detect the presence of nearby objects without any physical contact. The sensor component 1714 may also include a light sensor, such as a CMOS or CCD image sensor, for use in an imaging application. In some embodiments, the sensor component 1714 may also include an acceleration sensor, a gyroscope sensor, a magnetic sensor, a pressure sensor, or a temperature sensor.

The communication component 1716 is configured to facilitate wired or wireless communication between the terminal device 1700 and other devices. The terminal device 1700 may access a wireless network based on a communication standard, such as WiFi, 2G, 3G, or a combination of them. In an exemplary embodiment, the communication component 1716 receives, via a broadcast channel, a broadcast signal or broadcast related information from an external broadcast management system. In an exemplary embodiment, the communication component 1716 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the terminal device 1700 may be implemented by at least one application specific integrated circuit (ASIC), digital signal processor (DSP), digital signal processing device (DSPD), programmable logic device (PLD), field programmable gate array (FPGA), controller, microcontroller, microprocessors, or other electronic component to execute the methods.

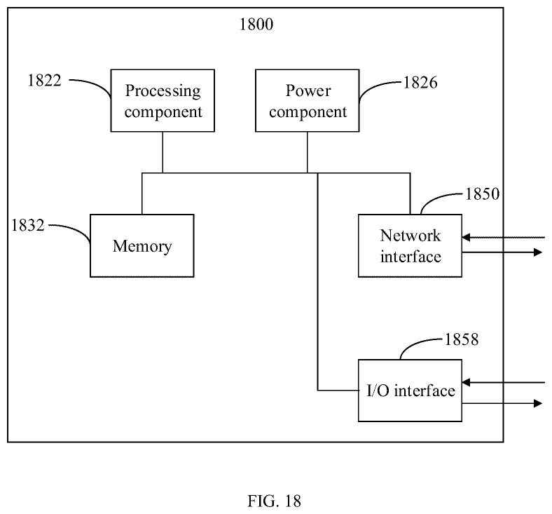

FIG. 18 is a block diagram of a base station 1800 provided by an embodiment of the present disclosure. For example, the base station 1800 may be provided as one base station. Referring to FIG. 18, the base station 1800 includes a processing component 1822 that further includes at least one processor (not shown), and memory resources represented by a memory 1832, for storing instructions that is executable by the processing component 1822, such as an application program. The application program stored in the memory 1832 may include one or more modules that each corresponds to a set of instructions. In addition, the processing component 1822 is configured to execute instructions to execute any method applied to the base station in the methods, for example, the method shown in FIG. 1.

The base station 1800 may also include a power component 1826 configured to execute power management of the base station 1800, a wired or wireless network interface 1850 configured to connect the base station 1800 to the network, and an input/output (I/O) interface 1858. The base station 1800 may operate an operating system stored in the memory 1832, such as Windows Server TM, Mac OS XTM, Unix TM, Linux TM, Free BSDTM, or a similar operating system.

In the embodiments provided by the present disclosure, the methods provided by the embodiments of the present disclosure are introduced from the perspectives of the base station, the terminal device, and the assistance communication device. To implement various functions in the methods provided in the embodiments of the present disclosure, the base station and the terminal device may include a hardware structure and a software module, to implement the functions in a form of the hardware structure, the software module, or a combination of the hardware structure and the software module. A certain function in the functions may be executed by using a hardware structure, a software module, or a combination of the hardware structure and the software module.

In the embodiments provided by the present disclosure, the methods provided by the embodiments of the present disclosure are introduced from the perspectives of the base station, the terminal device, and the assistance communication device. To implement various functions in the methods provided in the embodiments of the present disclosure, the network device and the terminal device may include a hardware structure and a software module, to implement the functions in a form of the hardware structure, the software module, or a combination of the hardware structure and the software module. A certain function in the functions may be executed by using a hardware structure, a software module, or a combination of the hardware structure and the software module.

An embodiment of the present disclosure provides a communication apparatus. The communication apparatus may include a transceiving module and a processing module. The transceiving module may include a transmitting module and/or a receiving module. The transmitting module is configured to implement a transmitting function, the receiving module is configured to implement a receiving function, and the transceiving module may implement the transmitting function and/or the receiving function.

The communication apparatus may be a terminal device (for example, the terminal device in the method embodiments), may be an apparatus in the terminal device, or may be an apparatus that can be matched with the terminal device for use. Alternatively, the communication apparatus may be a network device, may be an apparatus in the network device, or may be an apparatus that can be matched with the network device for use.

An embodiment of the present disclosure provides another communication apparatus. The communication apparatus may be a network device or a terminal device, or may be a terminal device (for example, the terminal device in the method embodiments), or may be a chip, a chip system, or a processor that supports the network device to implement the methods, etc., or may be a chip, a chip system, or a processor that supports the terminal device to implement the methods. This apparatus may be configured to implement the methods described in the method embodiments, which may specifically refer to the description in the method embodiments.

The communication apparatus may include one or more processors. The processors may be general-purpose processors, special-purpose processors, etc. For example, the processors may be baseband processors or central processing units. The baseband processor may be used to process a communication protocol and communication data, and the central processing unit may be used to control the communication apparatus (for example, a network device, a baseband chip, a terminal device, a terminal device chip, a DU, a CU, etc.), execute a computer program, and process data of the computer program.

Optionally, the communication apparatus may further include one or more memories. The one or more memories may store a computer program, and the processor executes the computer program to cause the communication apparatus to execute the methods described in the method embodiments. Optionally, the memory may further store data. The communication apparatus and the memory may be separately configured, or may be integrated together.

Optionally, the communication apparatus may further include a transceiver and an antenna. The transceiver may be referred to as a transceiving unit, a transceiving machine, a transceiving circuit, etc., and is configured to implement a transceiving function. The transceiver may include a receiver and a transmitter. The receiver may be referred to as a receiving machine, a receiving circuit, etc., and is used to implement a receiving function. The transmitter may be referred to as a transmitting machine, a transmitting circuit, etc., and is used to implement a transmitting function.

Optionally, the communication apparatus may further include one or more interface circuits. The interface circuits are used to receive code instructions and transmit the code instructions to the processor. The processor executes the code instructions to cause the communication apparatus to execute the methods described in the method embodiments.

The communication apparatus is an assistance communication device, and the processor is used to execute any method shown in FIGS. 1-7.

The communication apparatus is a network device, and the processor is used to execute any method shown in FIGS. 8-12.

The communication apparatus is a terminal device, and the processor is used to execute the method shown in FIG. 13.

In an implementation, the processor may include a transceiver for implementing the receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used to read and write codes/data, or the transceiving circuit, the interface, or the interface circuit may be used to transmit or transfer a signal.

In an implementation, the processor may store a computer program, and the computer program runs on the processor, so that the communication apparatus may execute the methods described in the method embodiments. The computer program may be fixed in the processor, and in this situation, the processor may be implemented by hardware.

In an implementation, the communication apparatus may include a circuit, and the circuit may implement transmitting, receiving, or communicating functions in the method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the embodiments may be a network device or a terminal device (for example, the terminal device in the method embodiments), but a scope of the communication apparatus described in the present disclosure is not limited thereto, and a structure of the communication apparatus may not be limited. The communication apparatus may be a separate device or may be a part of a larger device. For example, the communication apparatus may be: (1) a separate integrated circuit IC, chip, or chip system or subsystem; (2) a set of one or more ICs; optionally, the set of ICs may also include a storage component for storing data and a computer program; (3) an ASIC, for example, a modem; (4) a module that may be embedded within other devices; (5) a receiving machine, a terminal device, an intelligent terminal device, a cellular phone, a wireless device, a handset, a mobile unit, an in-vehicle device, a network device, a cloud device, an artificial intelligence device, etc.; or (6) other apparatus, etc.

In the case that the communication apparatus may be a chip or a chip system, the chip includes a processor and an interface. There may be one or more processors, and there may be multiple interfaces.

Optionally, the chip further includes a memory, and the memory is used to store a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a non-transitory computer-readable storage medium storing instructions. When the instructions are executed by a computer, functions of any one of the method embodiments are implemented.

The present disclosure further provides a computer program product. When the computer program product is executed by a computer, the functions of any one of the method embodiments are implemented.

The embodiments may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first,” “second,” “third,” “A,” “B,” “C,” and “D,” etc., and there is no an early-later sequence or a large-small sequence among the technical features described by “first,” “second,” “third,” “A,” “B,” “C,” and “D”.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described herein and shown in the accompanying drawings, and various modifications and changes may be made without departing from its scope. The scope of the present disclosure is limited only by the appended claims.

An embodiment in an aspect of the present disclosure provides a sending apparatus for an assistance communication device. The apparatus includes: an obtaining module, configured to obtain indication information for the assistance communication device, where the indication information includes CSI and/or a sending scheme; and a precoding module, configured to execute precoding for the assistance communication device based on the indication information, to implement transceiving of signals.

An embodiment in yet another aspect of the present disclosure provides a sending apparatus for an assistance communication device. The apparatus includes: a sending module, configured to send indication information for the at least one assistance communication device to the at least one assistance communication device, where the indication information includes CSI and/or a sending scheme.

An embodiment in yet another aspect of the present disclosure provides a sending apparatus for an assistance communication device. The apparatus includes: a sending module, configured to send indication information for the assistance communication device to a network device, where the indication information includes CSI.

An embodiment in yet another aspect of the present disclosure provides a communication apparatus. The communication apparatus includes a processor and an interface circuit; where the interface circuit is configured to receive code instructions and transmit the code instructions to the processor; and the processor is configured to execute the code instructions to execute the method provided in the embodiment in the first aspect.

An embodiment in yet another aspect of the present disclosure provides a communication apparatus. The communication apparatus includes a processor and an interface circuit; where the interface circuit is configured to receive code instructions and transmit the code instructions to the processor; and the processor is configured to execute the code instructions to execute the method provided in the embodiment in the second aspect.

An embodiment in yet another aspect of the present disclosure provides a communication apparatus. The communication apparatus includes a processor and an interface circuit; where the interface circuit is configured to receive code instructions and transmit the code instructions to the processor; and the processor is configured to execute the code instructions to execute the method provided in the embodiment in the third aspect.

1. A sending method for an assistance communication device, applied to the assistance communication device, comprising:
obtaining indication information for the assistance communication device, wherein the indication information comprises at least one of channel state information (CSI) or a sending scheme; and
executing precoding for the assistance communication device based on the indication information, to implement transceiving of signals.

2. The method of claim 1,
wherein obtaining indication information for the assistance communication device, comprises:
obtaining the indication information sent by a network device;
wherein the CSI comprises at least one of:
a precoding matrix;
a precoding matrix index (PMI);
an offset phase value;
a reference signal receiving power (RSRP); or
a direct or indirect identifier of a measurement reference signal, for indicating the measurement reference signal corresponding to the CSI.

3. The method of claim 2,
wherein the offset phase value for the assistance communication device is a difference value between a phase of transceiving signals on a channel for the assistance communication device and a phase of transceiving signals on a channel for a reference assistance communication device;
wherein the reference assistance communication device is any one selected assistance communication device other than the assistance communication device.

4. The method of claim 1, wherein executing precoding for the assistance communication device based on the indication information, comprises:
in response to determining that the indication information is the sending scheme for the assistance communication device, executing directly the precoding for the assistance communication device based on the obtained sending scheme; or
in response to determining that the indication information is the CSI, determining the sending scheme based on the CSI, and
executing the precoding for the assistance communication device based on the sending scheme.

5. (canceled)

6. The method of claim 1, wherein
the assistance communication device is a smart repeater, and
the sending scheme comprises at least one of precoding information or sending power information, and the precoding information comprises a precoding matrix index (PMI).

7. (canceled)

8. The method of claim 1, wherein
the assistance communication device is a reconfigurable intelligent surface (RIS), and
the sending scheme comprises precoding information, and the precoding information comprises at least one of a precoding matrix index (PMI) or incident angle information.

9. (canceled)

10. A sending method for at least one assistance communication device, applied to a network device, comprising:
sending indication information for the at least one assistance communication device to the at least one assistance communication device, wherein the indication information comprises at least one of channel state information (CSI) or a sending scheme.

11. The method of claim 10, wherein the CSI comprises at least one of:
a precoding matrix;
a precoding matrix index (PMI);
an offset phase value, for indicating a difference value between a phase of transceiving signals on a channel for the at least one assistance communication device and a phase of transceiving signals on a channel for a reference assistance communication device, wherein the reference assistance communication device is any one selected assistance communication device;
a reference signal receiving power (RSRP); or
a direct or indirect identifier of a measurement reference signal, for indicating the measurement reference signal corresponding to the CSI.

12. (canceled)

13. The method of claim 10, wherein before sending the indication information for the at least one assistance communication device to the at least one assistance communication device, the method further comprises:
obtaining the CSI for the at least one assistance communication device from a terminal device; and one of
determining the CSI for the at least one assistance communication device as the indication information, or
determining, based on the CSI for the at least one assistance communication device, the sending scheme for the at least one assistance communication device, and determining the sending scheme for the at least one assistance communication device as the indication information.

14. (canceled)

15. The method of claim 10, wherein the
at least one assistance communication device is a smart repeater, and
the sending scheme comprises at least one of precoding information or sending power information, and the precoding information comprises a precoding matrix index (PMI).

16. (canceled)

17. The method of claim 10, wherein
the at least one assistance communication device is a reconfigurable intelligent surface (RIS), and
the sending scheme comprises precoding information, and the precoding information comprises at least one of a precoding matrix index (PMI) or incident angle information.

18. (canceled)

19. A sending method for an assistance communication device, applied to a terminal device, comprising:
sending indication information for the assistance communication device to a network device, wherein the indication information comprises channel state information (CSI).

20. The method of claim 19, wherein the CSI comprises at least one of:
a precoding matrix;
a precoding matrix index (PMI);
an offset phase value, for indicating a difference value between a phase of transceiving signals on a channel for the assistance communication device and a phase of transceiving signals on a channel for a reference assistance communication device, wherein the reference assistance communication device is any one selected assistance communication device other than the assistance communication device;
a reference signal receiving power (RSRP); or
a direct or indirect identifier of a measurement reference signal, for indicating the measurement reference signal corresponding to the CSI.

21. (canceled)

22. The method of claim 19, wherein the sending indication information for the assistance communication device to the network device, comprises at least one of:
directly sending the indication information for the assistance communication device to the network device; or
sending, through the assistance communication device, the indication information for the assistance communication device to the network device.

23-25. (canceled)

26. A communication apparatus, comprising a processor and a memory, wherein the memory stores a computer program, and the processor, when executing the computer program stored in the memory, causes the processor to execute the method of claim 1.

27. A communication apparatus, comprising a processor and a memory, wherein the memory stores a computer program, and the processor, when executing the computer program stored in the memory, causes the processor to execute the method of claim 10.

28. A communication apparatus, comprising a processor and a memory, wherein the memory stores a computer program, and the processor, when executing the computer program stored in the memory, causes the processor to execute the method of claim 19.

29-31. (canceled)

32. A non-transitory computer-readable storage medium, configured to store instructions, wherein when the instructions are executed, the method of claim 1 is implemented.

33. A non-transitory computer-readable storage medium, configured to store instructions, wherein when the instructions are executed, the method of claim 10 is implemented.

34. A non-transitory computer-readable storage medium, configured to store instructions, wherein when the instructions are executed, the method of claim 19 is implemented.
